(19) United States
(12) Patent Application Publication
(10) Pub. No.: US 2012/0287007 A1
(43) Pub. Date: Nov. 15, 2012

(54) Method and Apparatus for Reflector Antenna with Vertex Region Scatter Compensation

(75) Inventors: Chris Hills, Glenrothes (GB); John Curran, Kirkcaldy (GB); Bruce Hughes, Lochgelly (GB)

(73) Assignee: ANDREW LLC, Hickory, NC (US)

(21) Appl. No.: 13/511,685

(22) PCT Filed: Dec. 3, 2010
(86) PCT No.: PCT/IB2010/055582

§ 371 Date: May 24, 2012

Related U.S. Application Data
(60) Provisional application No. 61/286,815, filed on Dec. 16, 2009.

(51) Int. Cl. H01Q 13/02

(52) U.S. Cl. 343/781 P

(57) ABSTRACT

A method and apparatus for enhancing the electrical performance of a reflector antenna. A boom disc mounted upon a feed waveguide supporting a subreflector is dimensioned and positioned for reflection cancellation against the reflected components from the reflector vertex region in the direction of edge illumination half angle T. A dielectric sleeve or RF absorbing material may be placed between the vertex region and the boom disc.

### CROSS REFERENCE TO RELATED APPLICATIONS

This application claims the benefit of U.S. Provisional Patent Application No.: 61/286,815, titled “Method and Apparatus for Reflector Antenna with Vertex Region Scatter Compensation” filed Dec. 16, 2009 by Chris Hills, John Curran and Bruce Hughes, hereby incorporated by reference in its entirety.

### BACKGROUND

1. Field of the Invention

This invention relates to microwave reflector antennas. More particularly, the invention relates to a reflector antenna with vertex region scatter compensation via an RF reflective surface on the boom of the feed assembly, which enhances the reflector antenna signal pattern characteristics.

2. Description of Related Art

Reflector Antenna feed assemblies typically utilize a vertex plate/forward feed hub surface positioned at the proximal end of a boom (feed waveguide) supporting a subreflector proximate a focal point of the reflector dish. The vertex plate typically improves the antenna Voltage Standing Wave Ratio (VSWR), an indicator of Return Loss.

Although an ideal reflector antenna would have a radiation pattern in which the entirety of the signal radiation is directed in a narrow forward beam, significant amounts of the signal radiate in undesired directions, including to the rear of the antenna. For terrestrial microwave communication systems, the sensitivity of the antenna radiation characteristics in the rearward hemisphere is a significant parameter for systems engineers reviewing potential sources of interference. Specifically, extraneous signals received by the antennas, either from adjacent links, or from within the designed link, can severely limit the carrier to noise ratio of the radio system, and thereby ultimately limit the system carrier capacity.

The amount of signal radiation directed forward with respect to an amount also radiating backward in the reflector antenna signal pattern is quantified as the front to back ratio (F/B) of the antenna. The F/B is regulated by international standards, and is specified by for example, the FCC in 47 CFR Ch.1 Part 101.115 in the United States, by ETSI in EN302217-4-1 and EN302217-4-12 in Europe, and by ACMA RALI FX 3 Appendix 11 in Australia.

Microwave parabolic antennas can be designed to meet these stringent regulatory requirements by minimizing the antenna's sensitivity to RF signals in the rear hemisphere. Feed radiation illumination in the direction of the periphery of the main reflector dish together with the geometry of the periphery region determine, via the mechanisms of diffraction and scattering, the radiation pattern characteristics of the antenna in the rear hemisphere and at the border region between front and rear hemispheres. Electromagnetic boundary conditions at the reflector dish rim provide cancellation of the electric field to incident vertical polarisation (H-plane), but provide continuity to the electric field to incident horizontal polarisation (E-plane). Thereby the radiation pattern levels in the horizontal, E-plane, will be higher than the corresponding H-plane in this border region.

The direct feed illumination at the periphery of the reflector known as edge-illumination can be controlled by effective design of the feed radiator. Measures such as the use of RF chokes or corrugations adjacent to the radiating aperture of the feed can effectively reduce the spill-over component, for example as disclosed in commonly owned U.S. Pat. No. 6,919,855, titled “Tuned Perturbation Cone Feed for Reflector Antenna” by Hills.

However, secondary illumination of the periphery of the reflector via scattering of the direct feed illumination from the main reflector particularly from the region adjacent to the reflector vertex can significantly degrade the edge illumination and lead to poor radiation pattern control, particularly in the transition region from front to rear hemispheres and into the rear hemisphere, thus preventing compliance to regulatory specifications.

Competition in the reflector antenna market has focused attention on improving electrical performance and minimization of overall manufacturing and installation costs. Therefore, it is an object of the invention to provide a reflector antenna that overcomes deficiencies in the prior art, including reduction of scattered radiation pattern components at the border region between front and rear hemispheres, and into the rear hemispheres.

### BRIEF DESCRIPTION OF THE DRAWINGS

The accompanying drawings, which are incorporated in and constitute a part of this specification, illustrate embodiments of the invention, where like reference numbers in the drawing figures refer to the same feature or element and may not be described in detail for every drawing figure in which they appear and, together with a general description of the invention given above, and the detailed description of the embodiments given below, serve to explain the principles of the invention.

FIG. 1 is a schematic cut-away view of a prior art deep dish reflector antenna.

FIG. 2 is a schematic cut-away view of FIG. 1, demonstrating the edge-illumination half-angle, T.

FIG. 3 is a schematic isometric view of an exemplary feed system with a boom disc.

FIG. 4 is a schematic partial cut-away view of the feed system of FIG. 3 mounted within a reflector antenna.

FIG. 5 is a schematic cross section view of FIG. 3.

FIG. 6 is a schematic isometric view of an exemplary embodiment of a feed system with a boom disc and RF absorbing material.

FIG. 7 is a schematic cross section view of FIG. 6.

FIG. 8 is a schematic cross section view of an exemplary embodiment of a feed assembly with a boom disc and a dielectric sleeve.

FIG. 9 is a schematic cross section view of an exemplary embodiment of a feed assembly with boom disc provided with an angled portion.

FIG. 10 is a schematic cross section view of an exemplary embodiment of a feed assembly with a boom disc provided with a periphery corrugation and an angled portion.

FIG. 11 is a schematic isometric view of an exemplary embodiment of a feed assembly with a boom disc provided with a periphery corrugation and an angled portion.

FIG. 12 is a chart illustrating a typical relationship between the worse case edge taper and boom disc axial position, for a 2 wavelength diameter boom disc across a typical operating band (15 GHz).

FIG. 13 is a chart illustrating a typical relationship between worse case feed return loss and boom disc axial position for a 2 wavelength diameter boom disc across a typical operating band (15 GHz).

FIGS. 14a and 14b are charts illustrating a series of predicted E-plane and H-plane feed radiation patterns, respectively, at discrete frequencies across a typical operating band (eg 15 GHz) using the feed illustrated in FIG. 1 less vertex plate.

FIGS. 15a and 15b are charts illustrating a series of predicted E-plane and H-plane feed radiation patterns, respectively, at discrete frequencies across a typical operating band (eg 15 GHz) using the feed illustrated in FIG. 1, after assembly within a reflector antenna and includes a vertex plate for VSWR matching.

FIG. 15c is a chart illustrating the predicted E-plane antenna radiation pattern characteristics from the antenna design illustrated in FIG. 1 across a typical operating band (15 GHz).

FIGS. 16a and 16b are charts illustrating a series of predicted E-plane and H-plane feed radiation patterns, respectively, at discrete frequencies across a typical operating band (eg 15 GHz) using the feed of FIG. 3, after assembly within a reflector antenna and includes a vertex plate for VSWR matching and a boom disc.

FIG. 16c is a chart illustrating the predicted E-plane antenna radiation pattern characteristics from the antenna design illustrated in FIG. 4 across a typical operating band (15 GHz).

FIGS. 17 and 18 are charts illustrating the principal measured E-plane antenna assembly co-polar radiation patterns from this type of design at three discrete frequencies across a typical operating band (15 GHz) without and with a boom disc, respectively.

FIGS. 19 and 20 are charts illustrating the principal measured H-plane antenna assembly co-polar radiation patterns from this type of design at three discrete frequencies across a typical operating band (15 GHz) without and with a boom disc, respectively.

FIG. 21 is a chart illustrating electrical performance of the boom disc together with a dielectric sleeve positioned between the boom disc and vertex area, compared with the performance without dielectric sleeve, and also, without a boom disc.

### DETAILED DESCRIPTION

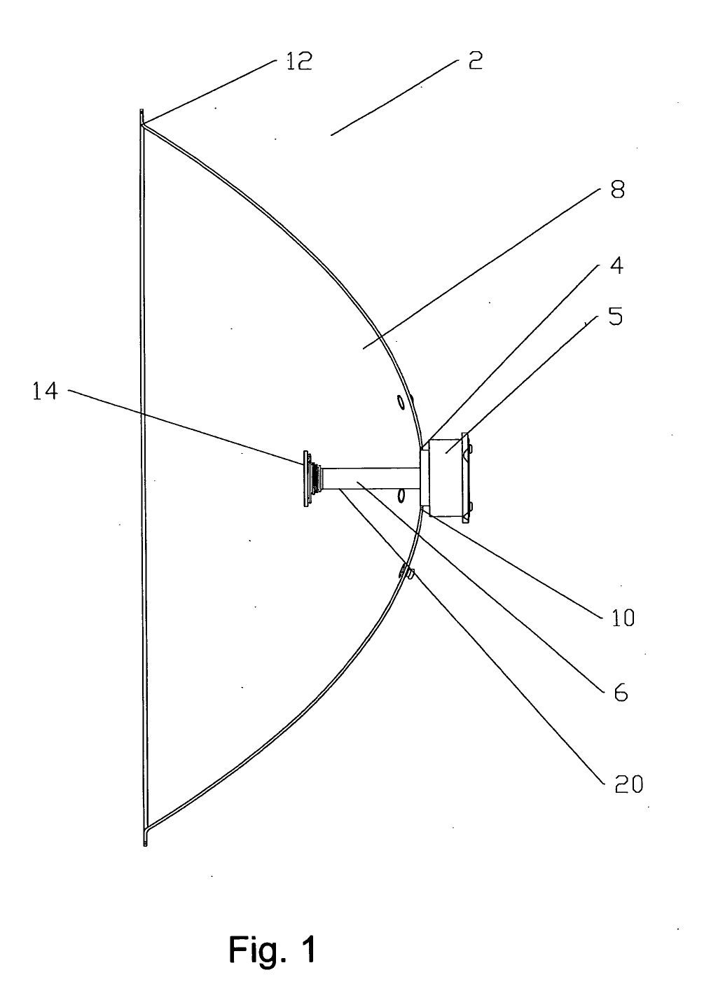

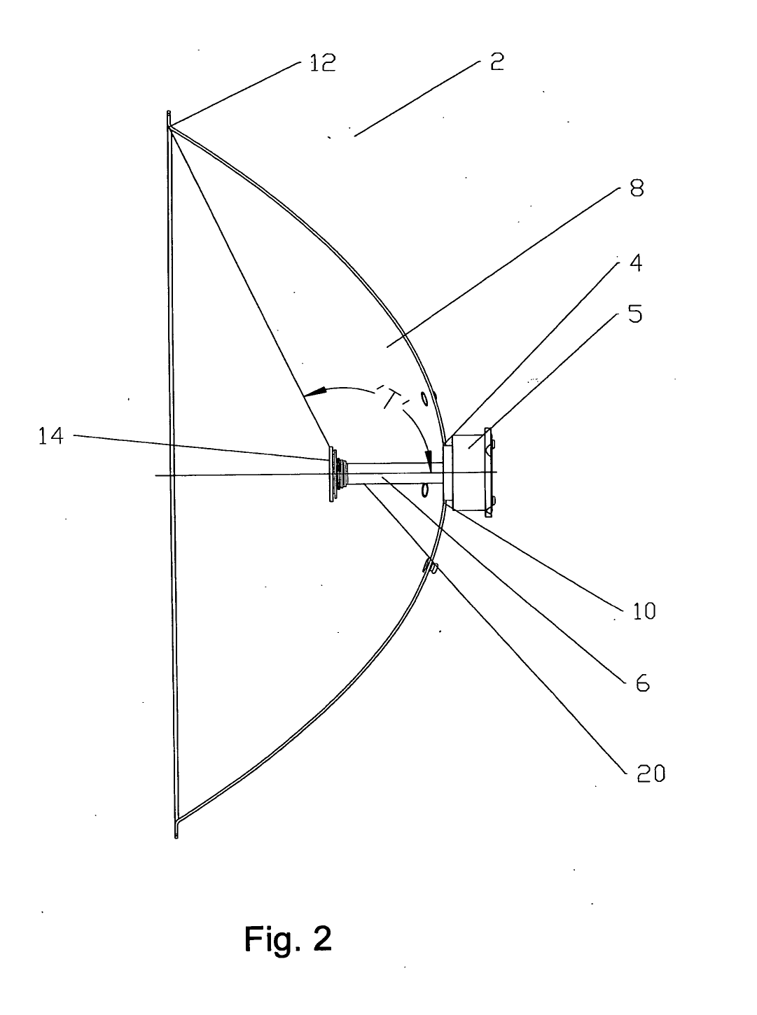

The inventors have analyzed the electrical performance of conventional deep dish reflector antennas (Focal Length/Diameter, F/D<=0.25), for example as shown in FIGS. 1 and 2, and discovered that although the presence of an RF reflective surface 4, such as a distal surface of the feed hub 5 or a vertex plate, at the proximal end of the feed waveguide (boom) 6 adjacent the reflector dish 8, the vertex region 10, provides significant VSWR improvement, feed radiation into the vertex region 10 (that is the on-axis and adjacent to on-axis component), can, by reflection and scatter from the vertex region 10 be re-radiated in the direction of the reflector dish periphery 12 and promote undesired signal reflection and diffraction particularly in the plane of horizontal polarization, or E-plane of the secondary radiation pattern.

The inventors have devised a method and apparatus for minimising the E-plane reflection and scatter of undesired feed radiation from the vertex region 10 to the reflector dish periphery 12 thus enabling edge illumination similar to that predicted from the feed design before integration with the reflector antenna 2 and thereby providing design level signal discrimination at the boundary between front and rear hemispheres and improving the F/B.

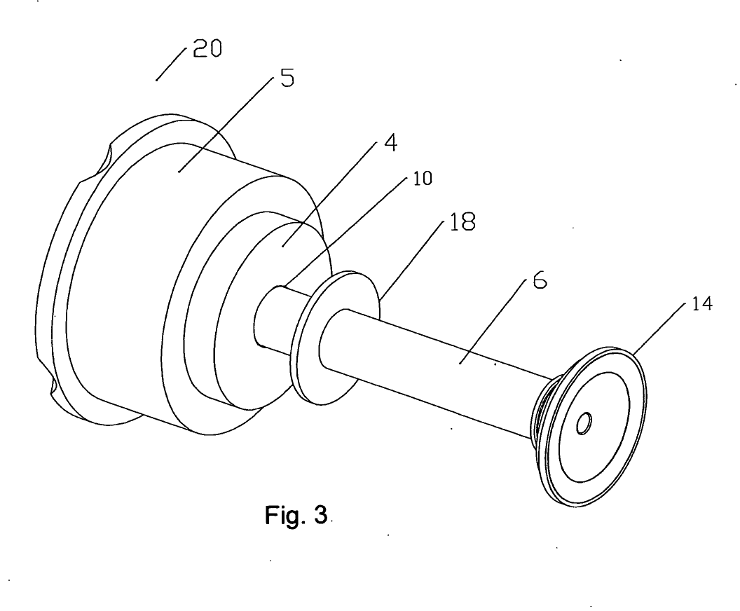

The addition of a boom disc 18, as shown for example in FIGS. 3-5, to the outer surface of the boom 6 provides a significant improvement in electrical performance of the reflector antenna 2. The boom disc 18 may provide an electromagnetic boundary condition such that a component of the on-axis, or close to on-axis feed radiation which would ordinarily be reflected/scattered by the vertex region 10 of the reflector antenna 2 is re-directed further into the forward hemisphere where its impact is of less significance. Thereby, the boom disc 18 reduces the extraneous reflected feed illumination components directed toward the reflector dish periphery 12.

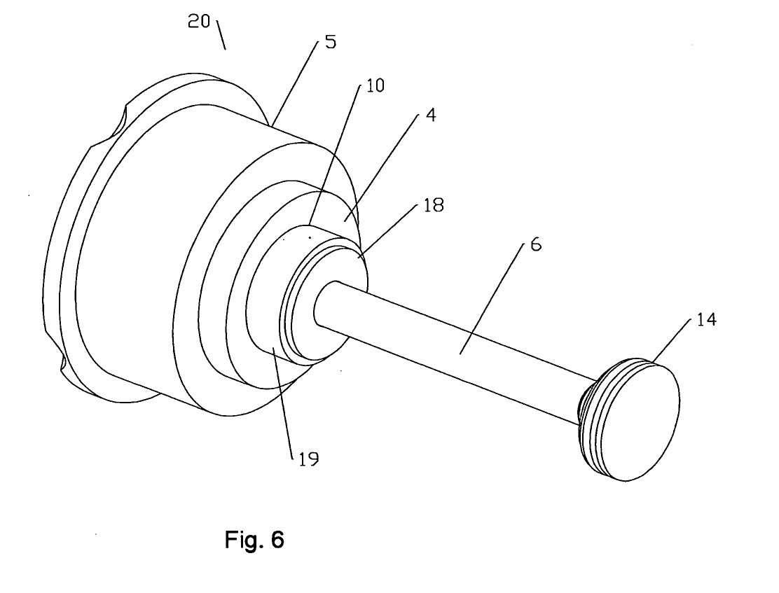

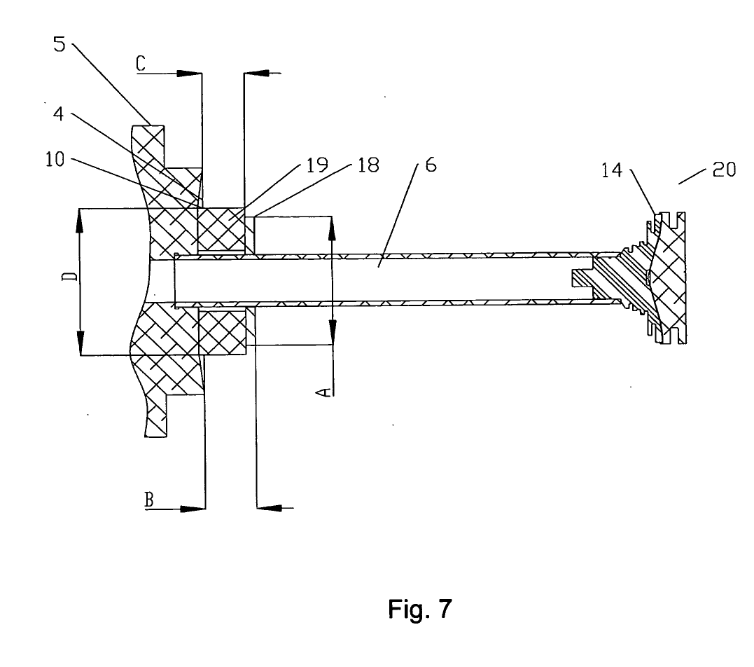

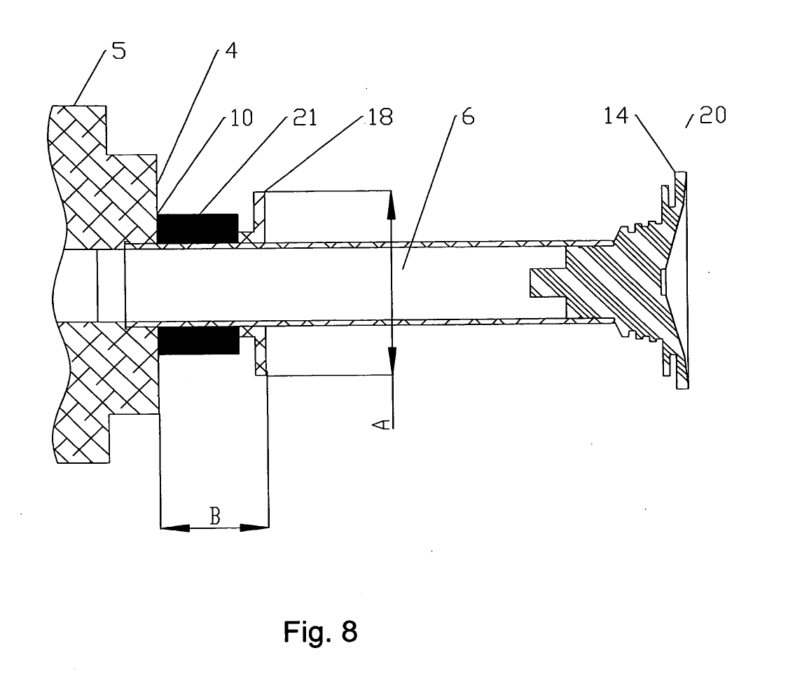

The inventors have observed that additional reduction in the scattered component in the direction of the reflector periphery can be achieved by the placement of Radio Frequency (RF) absorbing material 19, as shown for example in FIGS. 6 and 7, between the reflector vertex region 10 of the reflector antenna 2, and the boom disc 18. The inventors have also observed that the scattered component can be reduced in the direction of the reflector periphery by the placement of a dielectric sleeve 21 over the waveguide boom between the reflector vertex region 10 of the reflector antenna 2 and the rear face of the boom disc 18, as shown for example in FIG. 8.

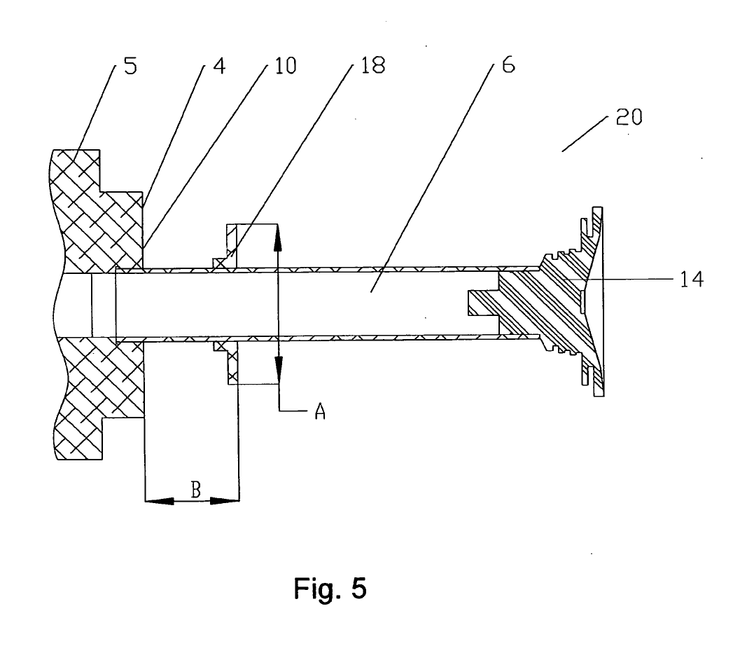

The boom disc 18 may be formed from metal, metalized or other RF reflective material and may be dimensioned and positioned as shown for example in FIG. 5, with respect to boom disc 18 outer diameter A and distance B between the distal surface of the boom disc 18 and the vertex region 10 (feed hub 5 distal surface or vertex plate). Typically initially between 1.75 and 2 wavelength, and between 0.25 and 1 wavelength respectively, dimensions A and B may be derived using contemporary RF software analysis tools such as Finite-Difference Time-Domain (FDTD) to optimize the radiation characteristics of the complete feed assembly 20 including the vertex region, which may then be confirmed by analysis and/or measurement of the complete reflector antenna 2.

Dimensions A and B are dependant on the type of feed illumination and are therefore determined by the numerical analysis based thereupon. A number of candidate axial positions can be identified each with separations of, for example, a multiple of one half a wavelength. It will be apparent to one experienced in the art that as the boom disc axial position moves closer to the subreflector 14 that the amplitude of the intercepted component will increase; the optimum position and diameter for reflection cancellation against the reflected components from the vertex region 10 in the direction of edge illumination half angle T, will therefore be dependant on the subreflector 14 configuration.

Once the first position of the boom disc 18 adjacent to the vertex region 10 has been identified, further minima at the requisite illumination half angle T are evident at spacing of multiples of one-half wavelength starting adjacent to the vertex region 10 according to the relation:

B=wavelength×(2N+1)/2,

Where N=integer

Dimension A is typically between 1.0 and 2.5 wavelengths of the desired operating frequency band.

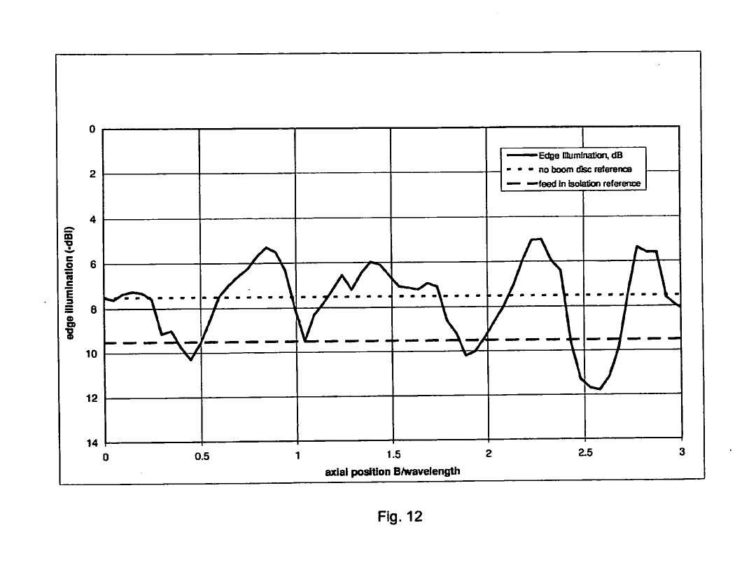

FIG. 12 shows a prediction of worse case feed edge illumination at a half angle T vs boom disc axial position B/wavelength for A=2 wavelengths diameter over the 15 GHz operating band.

The worse case prediction shown by FIG. 12 is for radiated signal level from the feed assembly 20 at the illumination half angle T, referred to as the edge illumination, against boom disc axial position, B (wavelengths) for a 2 wavelength diameter (A=2) boom disc 18 (over a 15 GHz operating band). The chart includes the edge illumination reference levels for the feed assembly 20 in isolation (less vertex plate and boom disc) and for the antenna feed with a vertex plate. The cyclic relationship between the axial position and the edge taper is evident; it can be seen in this example that boom disc axial positions of approximately 0.45, 1.9, and 2.6 will provide edge illumination levels equal to or lower than the design values predicted from the feed in isolation, and lower than the level predicted with no boom disc 18 present. In further embodiments, a diameter of the boom disc may be dimensioned, for example, between 1.0 and 2.5 wavelengths of a desired operating frequency and the boom disc positioned 0.25 to 3.0 wavelengths of the desired operating frequency from the front end of the feed hub.

As the boom disc 18 axial position moves closer to the sub-reflector 14, a degree of obscuration of the feed radiation will occur which in turn will impact the radiation characteristics of the reflector antenna 2. Furthermore the antenna return loss will also be influenced by the presence and position of the boom disc 18. Therefore in practice, a compromise may be determined by way of numerical and/or experimental analysis such that the boom disc 18 axial position that provides optimum suppression at the boundary and F/B regions also provides the requisite antenna return loss and radiation pattern directivity in the forward hemisphere in view of the priorities assigned to each of the boundary suppression and F/B characteristics.

FIG. 13 illustrates a worse case prediction for the feed return loss against the boom disc axial position, B (wavelengths) for a 2 wavelength diameter (A=2) boom disc 18 (over the 15 GHz operating band) after the arrangement illustrated in FIG. 12 where again the approximate one half wavelength cyclic nature of the effect of the selected boom disc 18 position is evident. Furthermore, it is evident that the best return loss does not necessarily coincide with the lowest edge taper, and therefore a compromise in the axial position whereby desired edge taper and return loss may be selected.

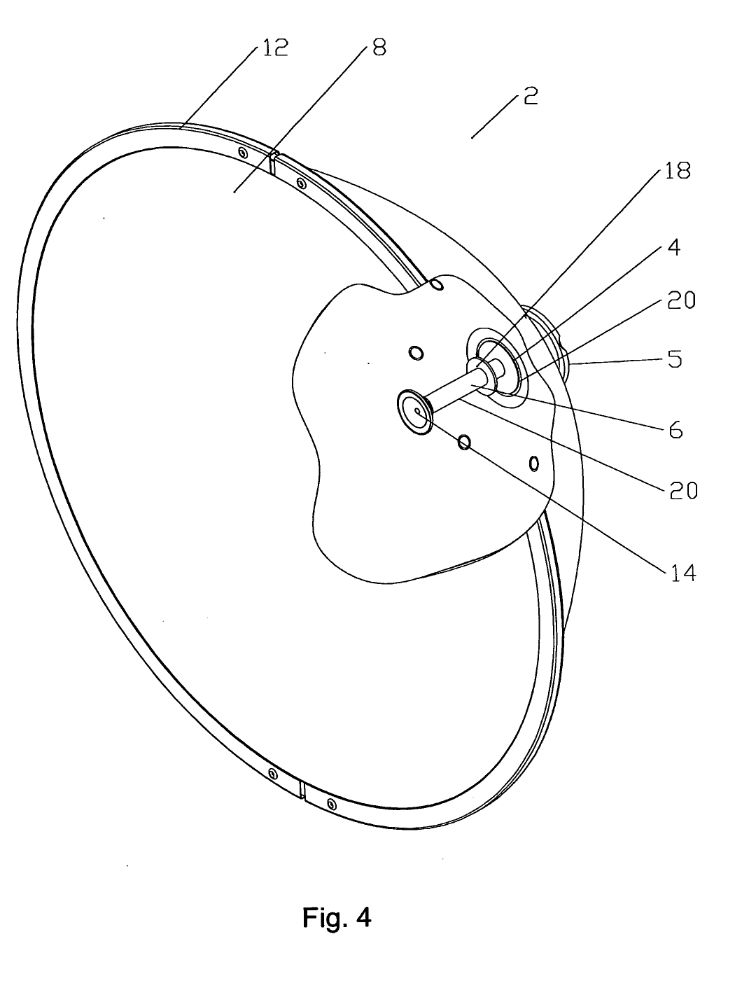

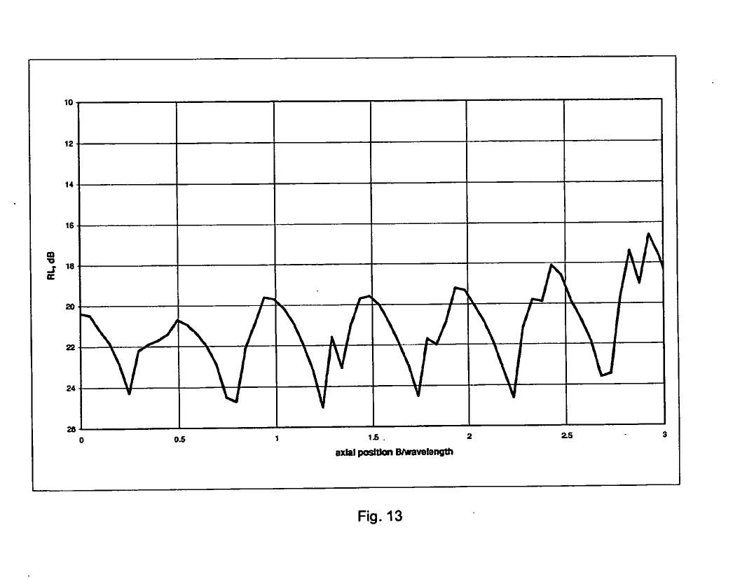

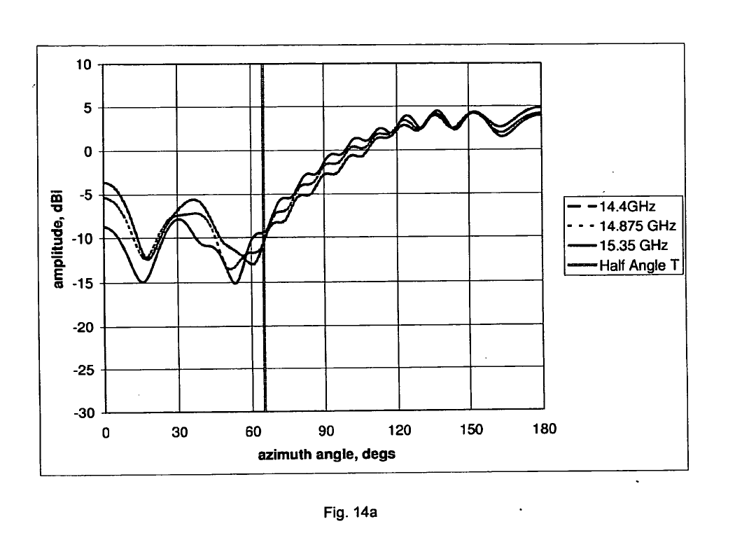

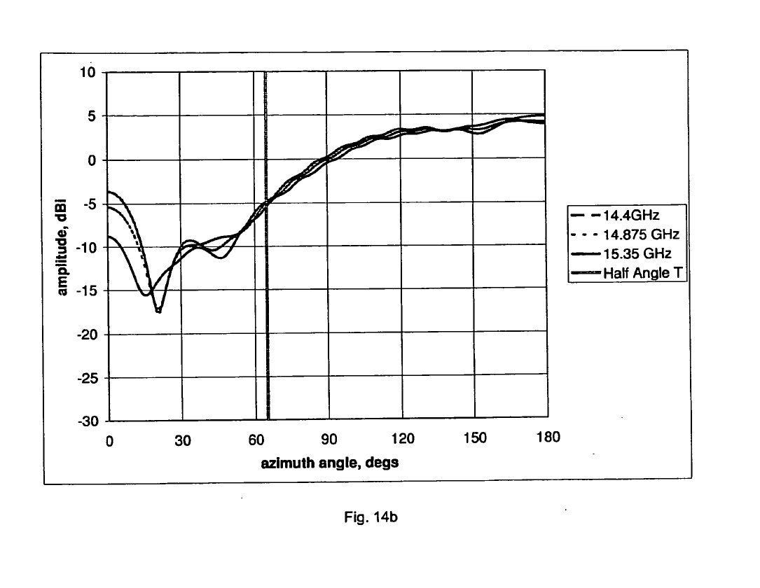

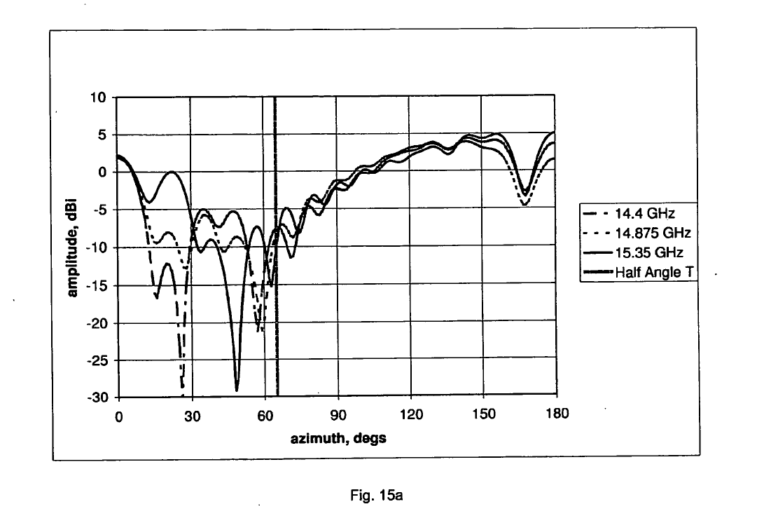

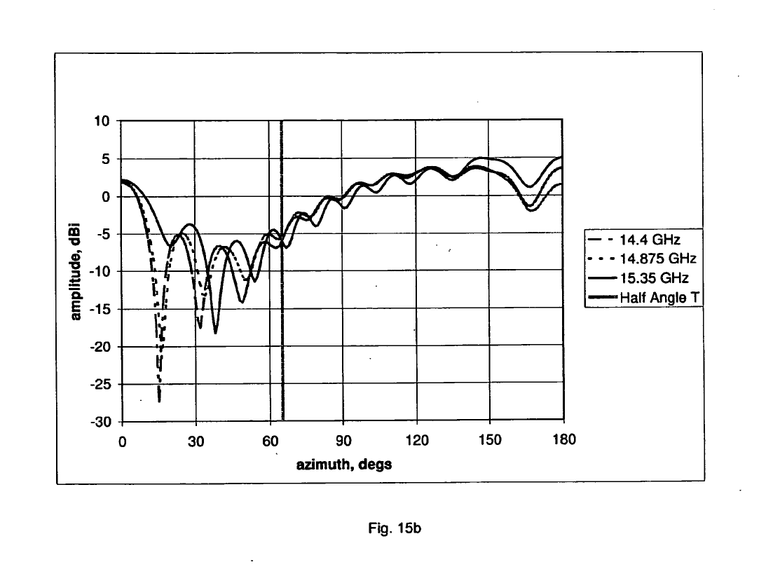

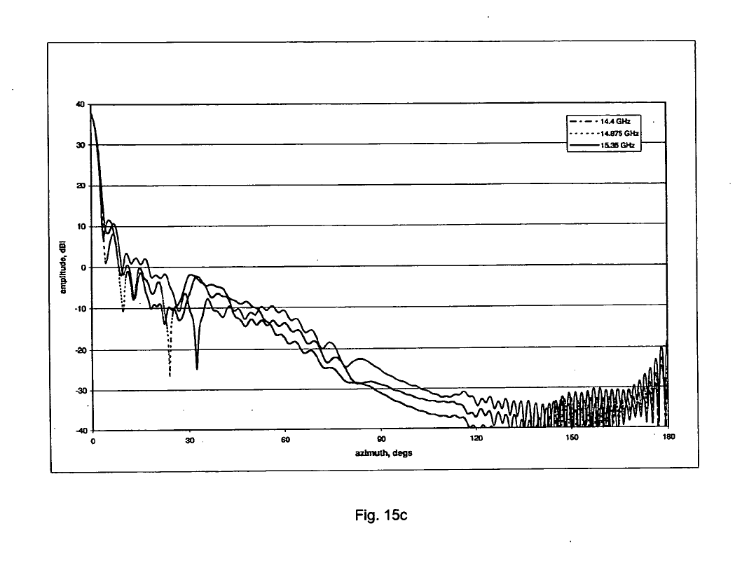

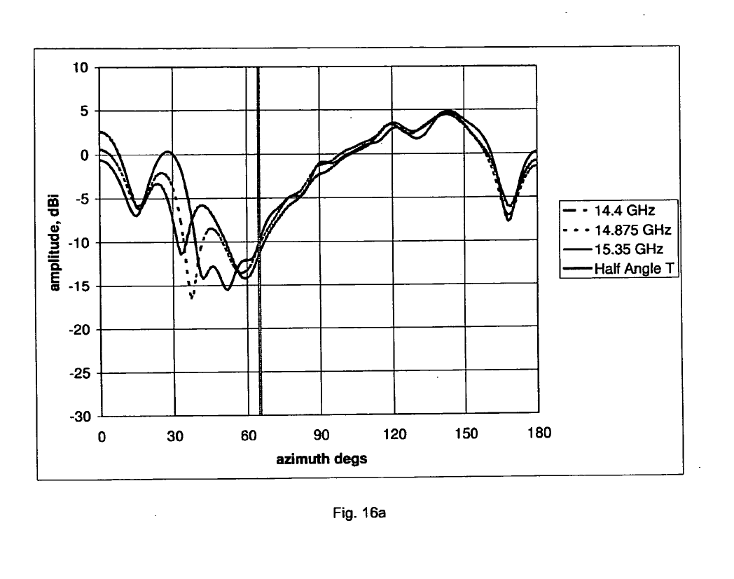

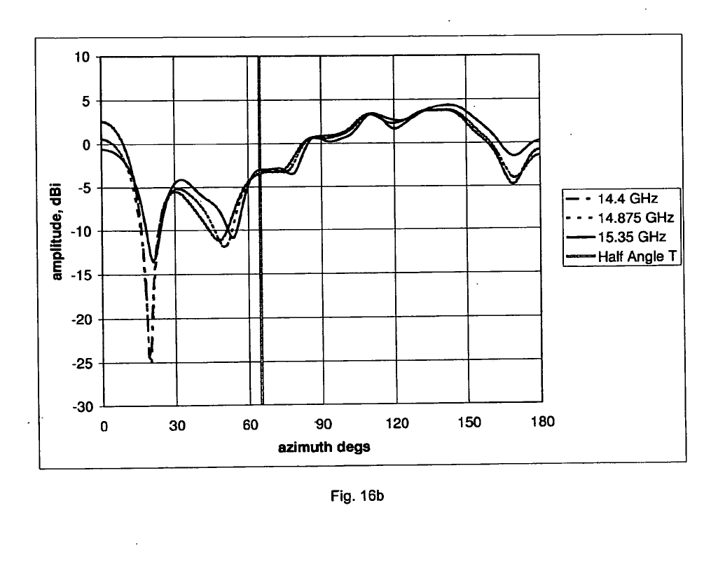

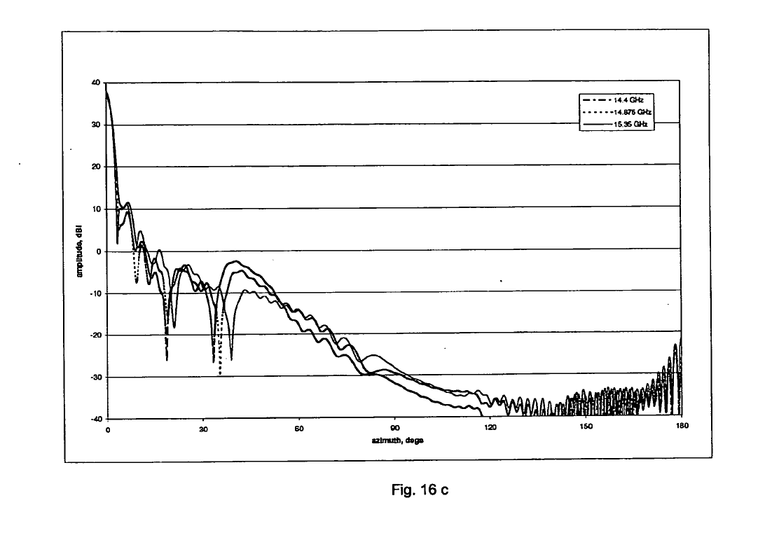

FIGS. 14a thru 16c demonstrate the impact of the boom disc 18 on the E-plane and H-plane feed radiation patterns. FIGS. 14a (E-plane) and 14b (H-plane) demonstrate the patterns from a feed assembly 20 designed in isolation (without a reflector dish 8). FIG. 15a demonstrates the degradation particularly in the E-plane at the edge-illumination half angle T, caused by reflection/scattering from a vertex plate. FIG. 15b demonstrates the degradation particularly in the H-plane at the edge-illumination half angle T, caused by reflection/scattering from a vertex plate. FIG. 15c illustrates the predicted E-plane antenna radiation pattern characteristics from the reflector antenna configuration of FIG. 1 (with vertex plate and no boom disc 18) across a typical operating band (15 GHz). FIG. 16a demonstrates the impact of a boom disc 18 with A=2 wavelength, B=2 wavelengths where the signal level in the E-plane at the illumination half angle is restored back to the design level of the feed established prior to insertion into the reflector dish 8. FIG. 16b demonstrates the impact of a boom disc 18 with A=2 wavelength, B=2 wavelengths where the signal level in the H-plane at the illumination half angle is restored back to the design level of the feed established prior to insertion into the reflector dish 8. FIG. 16c illustrates the predicted E-plane antenna radiation pattern characteristics from the reflector antenna configuration of FIG. 4 (with vertex plate and boom disc 18) across a typical operating band (15 GHz) with A=2 wavelength and B=2 wavelength.

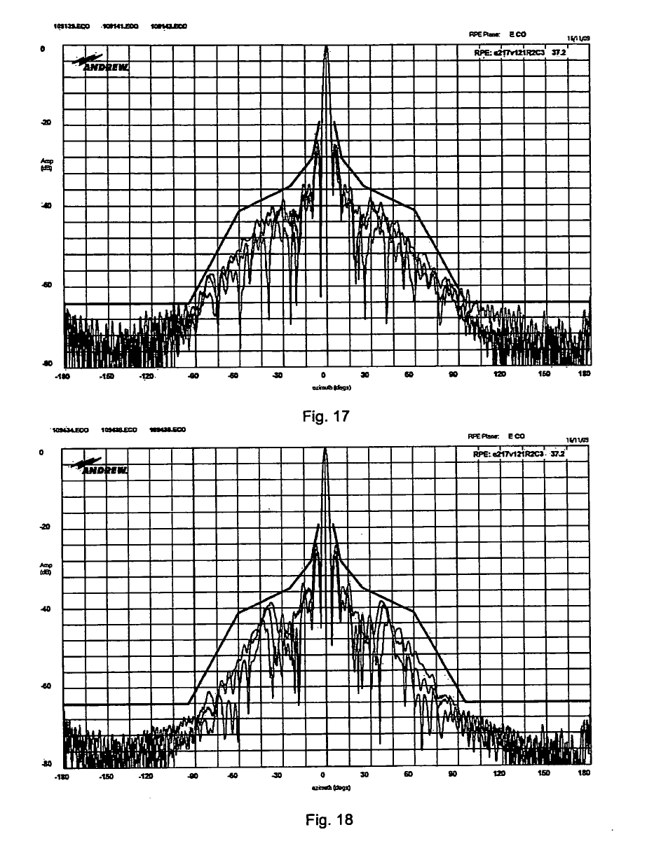

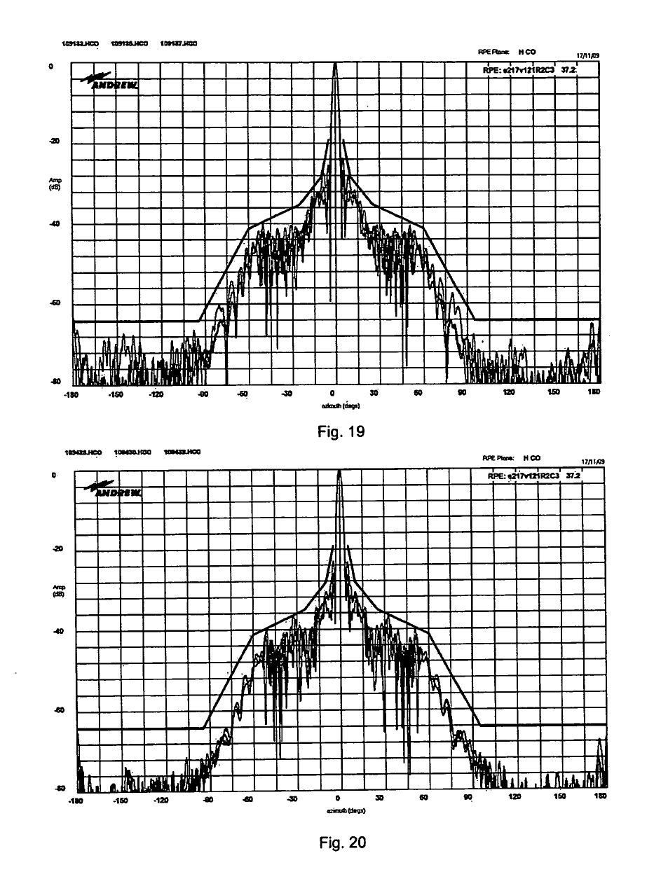

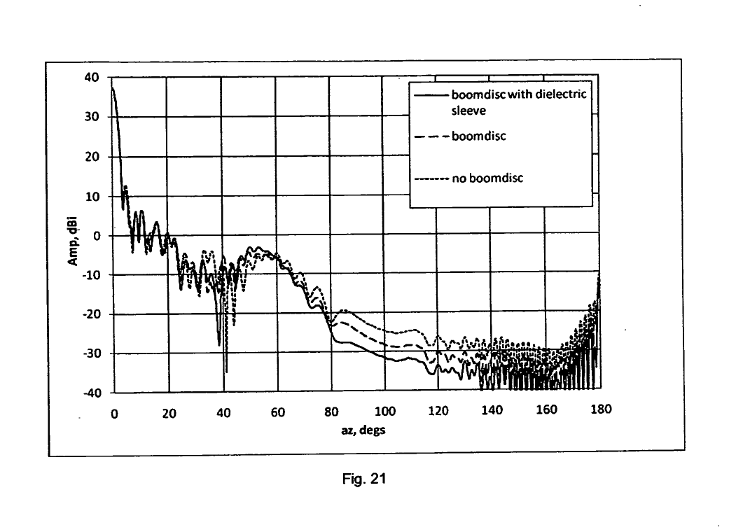

FIGS. 17-20 illustrate measured E-plane and H-plane co-polar radiation patterns of an exemplary 0.6 m diameter reflector antenna 2 with and without a boom disc 18 at three discrete frequencies across a typical operating band (15 GHz). The improvement in levels adjacent to the boundary region between front and rear transmission hemispheres is apparent as is the enhancement in F/B. It can be seen in this case that the presence of the boom disc 18 has facilitated compliance to ETSI radiation pattern envelope (Class 3) specification.

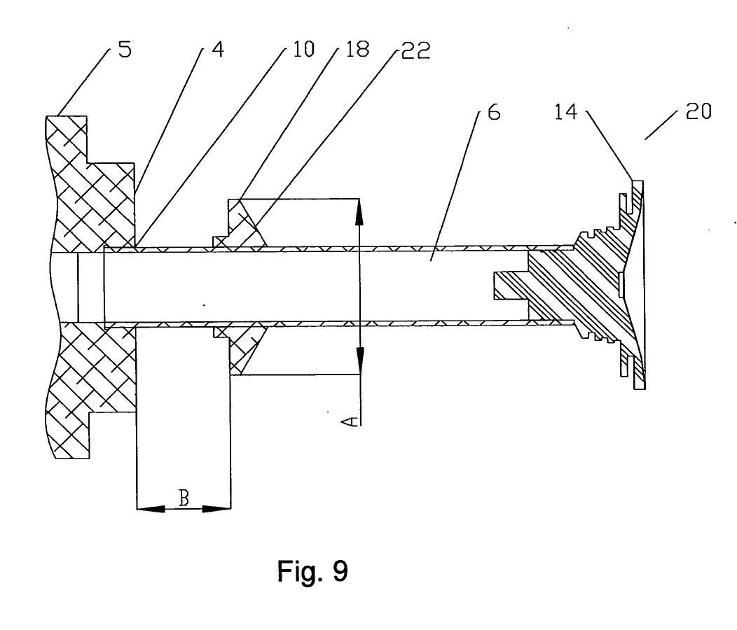

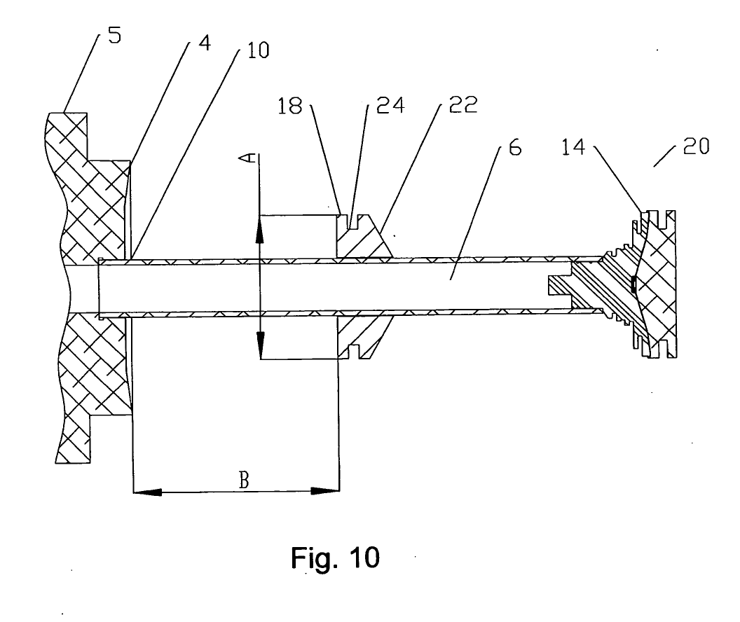

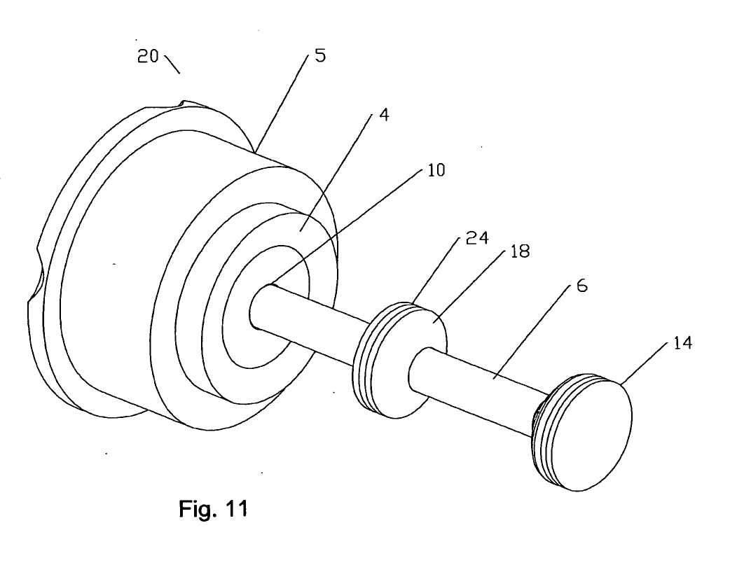

One skilled in the art will recognize that although the boom disc 18 is demonstrated in the exemplary embodiment as generally circular with a uniform periphery edge, the distal boom disc surface planar and normal to the boom longitudinal axis. In alternative embodiments, the boom disc shape and/or distal surface may be modified according to the desired electrical performance parameters, reflector dish and/or subreflector configuration. For example, as shown in FIGS. 9-10, the distal boom disc surface may be angled and/or have a curved surface with respect to the boom longitudinal axis. The periphery of the boom disc 18 may also be dimensioned with a peripheral dimension corresponding generally to dimensions of the reflector dish periphery 12, such as an elliptical configuration, to mate with the peripheral contours of an elliptical type reflector dish 8. Further, the periphery of the boom disc 18 may be provided with features, such as corrugations, as shown in FIGS. 10-11, according to the specific electrical performance desired.

Edge illumination is primarily an issue with so called “deep” reflector dishes 8 using circularly symmetric self supported waveguide feed assemblies 20 where the feed edge-illumination half-angles are >90 degrees, and where stringent regulatory specifications are to be achieved without the need for a conventional RF absorber-lined shield. However, the boom disc 18 may also be used in other reflector dish configurations where specific E-plane suppression of adjacent to on-axis radiation is desired towards the periphery of the reflector dish 8.

As mentioned previously, further suppression of the radiation pattern signal in the border regions between front and rear hemispheres can also be achieved by addition of a RF absorbing material 19 placed between the rear face of the boom disc 18 and the front face of the vertex region 10—see FIGS. 6-7. The precise dimensions of the RF absorbing material will be determined in response to the requisite specification, but an outside diameter corresponding to that of the boom disc is typical.

Additional enhancement can be achieved by use of a dielectric cylinder placed between the rear face of the boom disc and the front face of the vertex, 4. A typical dielectric constant of 2.1, corresponding to readily available PTFE, for example, can be readily designed, either empirically thru optimization on a test range, or by the use of FDTD software. The device is diameter sensitive and is typically between 1 and 5 mm in thickness.

FIG. 21 illustrates the performance enhancement that is readily available using the boom disc, optimized as above together with a dielectric sleeve, positioned between the boom disc and vertex area, compared with the performance that is achieved less sleeve, and also, less boom disc.

One skilled in the art will appreciate that significant improvements to the electrical performance of the reflector antenna 2 may be achieved by the addition of the boom disc 18 vertex plate scatter compensation feature, with minimal additional manufacturing and/or installation cost.

Table of Parts

| | |
|---|---|
| 2 | reflector antenna |
| 4 | reflective surface |
| 5 | feed hub |
| 6 | boom |
| 8 | reflector dish |
| 10 | vertex region |
| 12 | reflector dish periphery |
| 14 | subreflector |
| 18 | boom disc |
| 19 | radio frequency absorbing material |
| 20 | feed assembly |
| 21 | dielectric sleeve |
| 22 | angled portion |
| 24 | corrugation |

Where in the foregoing description reference has been made to materials, ratios, integers or components having known equivalents then such equivalents are herein incorporated as if individually set forth.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus, methods, and illustrative examples shown and described. Accordingly, departures may be made from such details without departure from the spirit or scope of applicant's general inventive concept. Further, it is to be appreciated that improvements and/or modifications may be made thereto without departing from the scope or spirit of the present invention as defined by the following claims.

We claim:

1. A feed assembly of a reflector antenna, the feed assembly comprising:
a feed hub;
a boom coupled to a front end of the feed hub;
a subreflector coupled to a front end of the boom; and
a boom disc coupled to an outer diameter of the feed waveguide between the feed hub and the subreflector.

2. The feed assembly of claim 1, wherein at least a portion of the front end of the feed hub is provided with a reflective surface.

3. The feed assembly of claim 1, wherein the boom disc is metal.

4. The feed assembly of claim 1, wherein the boom disc is circular.

5. The feed assembly of claim 1, wherein the boom disc is provided with an angled surface with respect to a longitudinal axis of the boom.

6. The feed assembly of claim 1, wherein the boom disc is elliptical.

7. The feed assembly of claim 1, wherein a periphery of the boom disc is provided with corrugations.

8. The feed assembly of claim 1, wherein the boom disc has a peripheral dimension corresponding to a peripheral dimension of a reflector dish coupled to the feed assembly.

9. The feed assembly of claim 1, wherein a diameter of the boom disc is between 1.0 and 2.5 wavelengths of a desired operating frequency.

10. The feed assembly of claim 1, wherein the boom disc is positioned 0.25 to 3.0 wavelengths of a desired operating frequency from the front end of the feed hub.

11. The feed assembly of claim 1, further including RF absorbing material between the boom disc and the feed hub.

12. The feed assembly of claim 1, further including a dielectric sleeve around the boom between the feed hub and the boom disc.

13. A method of reducing the F/B ratio of a reflector antenna, comprising the steps of:
providing a boom disc along an outer diameter of a boom between a feed hub and a subreflector;
the boom coupled to a front end of the feed hub;
the subreflector coupled to a front end of the boom.

14. The method of claim 13, wherein at least a portion of the front end of the feed hub is provided with a reflective surface.

15. The method of claim 13, wherein the boom disc is metal.

16. The method of claim 13, wherein the boom disc is circular.

17. The method of claim 13, wherein the predetermined diameter is between 1.0 and 2.5 wavelengths of a desired operating frequency.

18. The method of claim 13, wherein the boom disc is positioned 0.25 to 3.0 wavelengths of a desired operating frequency from the front end of the feed hub.

19. The method of claim 13, wherein alternative potential boom disc positions are identified according to an equation B=wavelength×(2N+1)/2, where N=integer and B is the distance from the feed hub.

20. A feed assembly of a reflector antenna, the feed assembly comprising:
a feed hub;
at least a portion of the front end of the feed hub provided with a reflective surface;
a boom coupled to a front end of the feed hub;
a subreflector coupled to a front end of the boom;
a metal boom disc coupled to an outer diameter of the boom between the feed hub and the subreflector;
a dielectric sleeve around the boom, between the feed hub and the boom disc;
the boom disc provided with a peripheral dimension corresponding to a peripheral dimension of a reflector dish coupled to the feed assembly;
a diameter of the boom disc dimensioned between 1.0 and 2.5 wavelengths of a desired operating frequency; and the boom disc positioned 0.25 to 3.0 wavelengths of a desired operating frequency from the front end of the feed hub.
